(19) United States
(12) Patent Application Publication
(10) Pub. No.: US 2003/0091386 A1
(43) Pub. Date: May 15, 2003

(54) Furniture joint

(75) Inventor: Peter Ting, Kowloon (HK)

Correspondence Address: John S. Egbert, Harrison & Egbert, 7th Floor, 412 Main Street, Houston, TX, 77002, US

(73) Assignee: Nique Enterprises Pty Ltd., Somersby (AU)

(21) Appl. No.: 10/097,533

(22) Filed: Mar. 13, 2002

(30) Foreign Application Priority Data
Nov. 12, 2001 (AU) PR8809

(51) Int. Cl. F16D 1/00

(52) U.S. Cl. 403/408.1

(57) ABSTRACT

A piece of furniture such as a table has a furniture joint system including a first component which may be a leg of the furniture, a second component which may be a structural horizontal frame member of the furniture, and a pair of joint members. Each joint member is immovably fixed to a respective one of the components. A connector prevents separation of the members along a separation axis and the members have mutually engaging formations preventing rotation and movement of one member relative to the other in a plane normal to the separation axis, to provide for a rigid and secure construction of the furniture.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention relates to a furniture joint system, to a furniture joint device, and to a table.

### BACKGROUND OF THE INVENTION

A known type of outdoor table has a frame which includes a rim forming part of the table top, and legs for carrying the rim, the legs being formed of tubing. The tubing, usually of extruded aluminum, has a cross-section which is in the form of an oblong, the two opposite sides of the oblong being straight and parallel and the two ends of the oblong each being substantially semi-circular. The tubing has two internal spaced webs extending from one of the parallel sides of the oblong to the other within the tubing. Thus, the webs define, and separate, three passages each extending along the length of the tubing.

The legs are joined, at their upper ends, to the rim, and extend downwardly from the rim. The table further includes an elongate frame member of tubing similar to that of the legs, which is disposed to extend horizontally such that its length defines a closed path, and which is positioned about two-thirds of the way up the legs. The frame member is formed such that the oblong cross-section of its tubing has its longer axis orientated vertically.

The frame member is fixed to an inner surface of each of the legs by a frame joint to provide stability to the table. Each frame joint includes a channel and a pair of nut-and-bolt combinations. The channels have their closed sides abutting the inner surface of the legs. The channels are orientated horizontally with the frame member being seated within the channels. The bolts extend from exterior surfaces of the legs through the leg tubing, the channel and the frame member, and are secured by the nuts. In some embodiments each frame joint includes a second channel, with the frame member tubing being sandwiched between the two channels of each joint, and clamped by means of the channels, nuts and bolts.

In order for the frame joints to provide stability to the table as required, the pair of nut-and-bolt combinations of each joint are vertically spaced apart from each other. Because the legs extend vertically, the nut-and-bolt combinations of each pair are spaced from each other along a portion of the length of the respective leg. However, the frame member is disposed horizontally, so that the spacing of the nut-and-bolt combinations results in each such combinations being disposed close to the upper and lower extremities of the frame-member tubing, that is, near the ends of the oblongs of the tubing. As this part of the tubing is relatively weak, it is a disadvantage of this construction that, if the nuts are made sufficiently tight, the tubing of the frame member is caused to deform inwardly. Furthermore, the nature of the joints and number of parts forming each joint, results in the forming of such joints being undesirably complicated or awkward.

It is an object of the present invention to overcome at least one disadvantage of the prior art or to provide a useful alternative.

### BRIEF SUMMARY OF THE INVENTION

According to a first aspect of the invention there is provided a furniture joint system for joining a first component of a piece of furniture to a second component of the piece of furniture, the system including:

a first joint member which is fixed to the first component so as to be immovable relative thereto and which has a first engagement formation;

a second joint member which is fixed to the second component so as to be immovable relative thereto and which has a second engagement formation complementary to, and engageable with, the first engagement formation; and

a connector for connecting said formations in mutual engagement and retaining said members against separation along a separation axis.

wherein said formations are configured, when mutually engaged. to prevent rotation of one of said members relative to the other member in a plane substantially normal to said separation axis.

Preferably, said formations are configured, when mutually engaged, to prevent movement of one of said members relative to the other member in a plane substantially normal to said separation axis.

In a preferred embodiment, the components are tubular. Then, preferably, the components are of oblong cross-section.

Preferably, the first joint member is welded to an outer surface of the first component and the second joint member is welded to an outer surface of the second component.

The first and second joint members are preferably each of aluminum.

In a preferred embodiment one of the first and second engagement formations is a female formation constituted by a non-circular recess defined in a respective member and the other of the first and second engagement formations is a non-circular male formation complementary to, and receivable in the recess. Preferably, each of said female formation and male formation is of oblong form.

Preferably, said connector is a threaded connector, which is preferably a bolt. In this case, preferably, one of said members defines a threaded bolt hole for screwing engagement with the bolt and the other member defines a further hole aligned with the threaded bolt hole when the formations are mutually engaged. The bolt preferably has an Allen screw bolt head. In a preferred embodiment, the particular tubular component to which the member defining the further hole is fixed defines an aperture aligned with said further hole, the bolt being passable through the aperture and then extendible through said further hole to screwingly engage with said bolt hole when said formations are mutually engaged. Said particular tubular component preferably has a wall from which a portion has been cut out to provide said aperture in the particular component.

In a preferred embodiment, said first component is one of a plurality of legs of the piece of furniture configured to extend generally upwardly when the piece of furniture is in use and said second tubular component is a frame member for providing structural support to the piece of furniture, the frame member being configured to extend substantially horizontally when the piece of furniture is in use. The piece of furniture is preferably a table.

According to a second aspect of the invention there is provided a furniture joint device for joining a first component of a piece of furniutre to a second component of the piece of furniture, the device including:

a first joint member, adapted to be immovably fixed to the first component, the first joint member having a first engagement formation;

a second joint member adapted to be immovably fixed to the second component, the second joint member having a second engagement formation complementary to, and engageable with, the first engagement formation, and

a connector for connecting said formations in mutual engagement and retaining said members against separation along a separation axis;

wherein said formations are configured, when mutually engaged, to prevent rotation of one of said members relative to the other member in a plane substantially normal to said separation axis.

According to a third aspect of the invention, there is provided a table including:

a plurality of systems according to the first aspect of the invention;

a plurality of legs configured to extend generally upwardly when the table is in use wherein each leg constitutes the first component of a respective one of said systems; and

a frame member which provides structural support to the table and which extends substantially horizontally when the table is in use, the frame member constituting the second component of all of said systems.

### BRIEF DESCRIPTION OF THE SEVERAL VIEWS OF THE DRAWINGS

A preferred embodiment of the invention will now be described, by way of example only, with reference to the accompanying drawings in which:

FIG. 1 is a schematic perspective view of a piece of furniture.

FIG. 2 is a schematic cross-sectional lengthwise view of piping forming part of the furniture of figure.

FIG. 3 is a schematic perspective view showing an exploded joint between two components of the furniture of FIG. 1; and

FIG. 4 is a schematic perspective exploded partly cut-away view of joint members forming part of an embodiment of the invention and used in tie joint of FIG. 3.

### DETAILED DESCRIPTION OF THE INVENTION

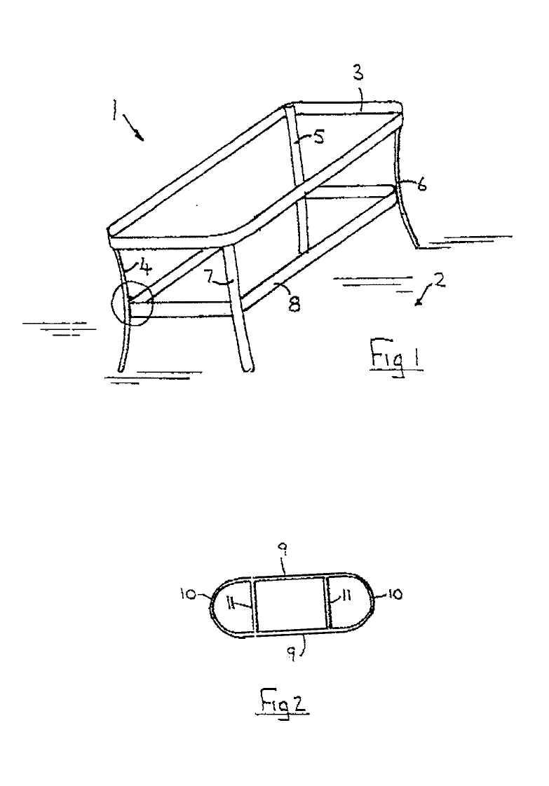

Referring to FIG. 1, there is shown a piece of furniture in the form of an outdoor table 1. The table is supported on a floor surface 2 and has an upper rim 3, legs 4, 5, 6 and 7 extending upwardly from the floor surface to the rim, and a frame member 8 attached to the legs, about two-thirds of the way up. The frame member 9 is for providing stability to the table 1. The rim 3 forms part of the table top and is configured to support a table top surface (not shown) such as a piece of glass. The manner of supporting the surface does not form part of the invention and is therefore not described further. Likewise, the manner in which the upper ends of the legs 4, 5, 6 and 7 are attached to the rim 3 is also not described further.

The legs 4, 5, 6 and 7 and the frame member 8 are each formed of extruded aluminum tubing having an oblong cross-section as illustrated in FIG. 2. It will be seen that the oblong of the cross-section includes two opposite parallel side 9 and semi-circular ends 10. Two inner webs 111 are provided which divide the interior of the tubing into three passages which extend along the length of the tubing.

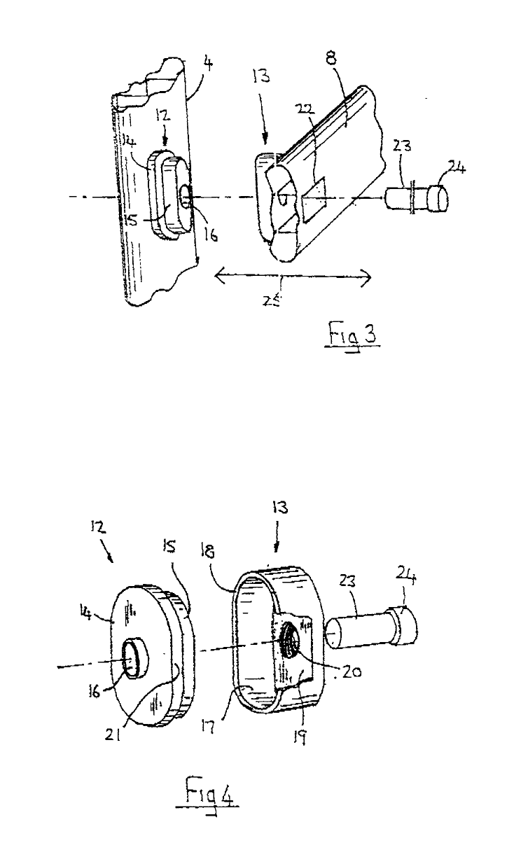

Referring to FIG. 3, there is shown, in more detail, part of two components of the table 1, being the leg 4 and the frame member 8, as a partial, enlarged, exploded view of the encircled detail of FIG. 1. Attached to an outer surface of the leg 4 by way of aluminum welding, is a joint member 12 and attached to an outer surface of the frame member 8, also by way of aluminum welding, is a further joint member 13. The joint members 12 and 13, shown in more detail in FIG. 4, are of cast aluminum and are each substantially oblong in shape.

The joint member 12 has a flange 14 and a formation 15, the flange defining, at its center, a screw-threaded bolt hole 16. The joint member 13 defines a recess in the form of the oblong socket 17 with walling 18 and a base 19. The formation 15 and the socket 17 have complementary tapers so that the formation is receivable within the socket as an easy sliding fit. Thus the formation 15 and socket 17 constitute male and female formations, respectively. In the base 19 of the socket 17 is a further hole 20 which is aligned with the bolt hole 16 when the formation 15 is received in the socket 17. The flange 14 is sized such that when the formation 15 is received in the socket 17, the peripheral surface 21 of the flange is flush with the outer surface of the walling 18.

The frame member 8 has a portion cut out thereby providing an aperture 22 that is aligned with the further hole 20. To attach the frame member 9 to the leg 4 in use, the frame member and leg are positioned with the members 12 and 13 in engagement—that is, with the formation 15 received in the socket 17. A bolt 23 is then passed through the aperture 22 and the further hole 20, and is screwed into the bolt hole 16. The bolt 23, which has an Allen key head 24, thus retains the members 12 and 13 in engagement with each other. The members 12 and 13 and the bolt 23 may, together, be considered as a device for connecting components of the table 1. A grommet (not shown) is provided for closing the aperture 22 once the bolt 23 has been inserted.

The bolt 23 applies a retaining force to the members 12 and 13, preventing them from disengaging in a direction parallel to the axis of the bolt, this direction of potential disengagement being referred to herein as a separation axis, as indicated by the arrow 25.

It will be noted that. as the members 12 and 13 are welded to their respective tubular components (the leg 4 and the frame member 8) they are immovable relative thereto. When the members 12 and 13 are engaged with each other ds described, their complementary oblong shapes ensure that one of the members cannot rotate or move relative to the other member in a plane normal to the separation axis 25. The combination of the effects of, on the one hand, the inter-engagement of the two non-circular members 12 and 13, and, on the other hand, the bolt 23, thus ensures that the joint between the leg 4 and the frame member 8 is secure both against coming part and against relative twisting. If similar joint systems, involving members corresponding to the members 12 and 13, and bolts corresponding to the bolt 23, are used between the frame member 8 and the other legs 5, 6 and 7, of the table 1, the table will be supported rigidly and securely. It will be appreciated that this rigid and secure support may be provided without any bolts or clamping members being tightened onto the respective tubular components, so that the resultant risk of crushing or deforming these members is avoided.

Although the invention is described herein with reference to the above embodiment, it will be understood by those skilled in the art that the invention may be embodied in many other forms.

I claim:

1. A furniture joint system for joining a first component of a piece of furniture to a second component of the piece of furniture, the system comprising:
a first joint member which is fixed to the first component so as to be immovable relative thereto and which comprises a first engagement formation;
a second joint member which is fixed to the second component so as to be immovable relative thereto and which comprises a second engagement formation complementary to, and engageable with, the first engagement formation; and
a connector for connecting said formations in mutual engagement and retaining said members against separation along a separation axis,
wherein said formations are configured, when mutually engaged, to prevent rotation of one of said members relative to the other member in a plane substantially normal to said separation axis.

2. The system of claim 1 wherein said formations, are configured, when mutually engaged, to prevent movement of one of said members relative to the other member in a plane substantially normal to said separation axis.

3. The system of claim 1 wherein the components are tubular.

4. The system of claim 3 wherein the components are of oblong cross-section.

5. The system of claim 1 wherein the first joint member is welded to an outer surface of the first component and the second joint member is welded to an outer surface of the second component.

6. The system of claim 1 wherein the first and second joint members are each of aluminum.

7. The system of claim 1 wherein one of the first and second engagement formations is a female formation constituted by a non-circular recess defined in a respective member and the other of the first and second engagement formation is a non-circular male formation complementary to, and receivable in the recess.

8. The system of claim 7 wherein each of said female formation and male formation is of oblong form.

9. The system of claim 1 wherein said connector is a threaded connector.

10. The system of claim 9 wherein the connector is a bolt.

11. The system of claim 10 wherein one of said members, defines a threaded bolt hole for screwing engagement with the bolt and the other member defines a further hole aligned with the threaded bolt hole when the formations are mutually engaged.

12. The system of claim 10 wherein the bolt has an Allen screw bolt head.

13. The system of claim 11 wherein the particular tubular component to which the member defining the further hole is fixed defines an aperture aligned with said further hole, the bolt being passable through the aperture and then extendible through said further hole to screwingly engage with said bolt hole when said formations are mutually engaged.

14. The system of claim 13 wherein said particular tubular component has a wall from which a portion has been cut out to provide said aperture in the particular component.

15. The system of claim 1 wherein said first component is one of a plurality of legs of the piece of furniture configured to extend generally upwardly when the piece of furniture is in use and said second tubular component is a frame member for providing structural support to the piece of furniture, the frame member being configured to extend substantially horizontally when the piece of furniture is in use.

16. The system of claim 15 wherein the piece of furniture is a table.

17. A furniture joint device for joining a first component of a piece of furniture to a second component of the piece of furniture, the device comprising:
a first joint member, adapted to be immovably fixed to the first component, the first joint member comprising a first engagement formation;
a second joint member adapted to be immovably fixed to the second component, the second joint member comprising a second engagement formation complementary to, and engageable with, the first engagement formation; and
a connector for connecting said formations in mutual engagement and retaining said members against separation along a separation axis.,
wherein said formations are configured. when mutually engaged, to prevent rotation of one of said members relative to the other member in a plane substantially normal to said separation axis.

18. A table comprising:
a plurality of systems according to claim 1;
a plurality of legs configured to extend generally upwardly when the table is in use wherein each leg constitutes the first component of a respective one of said systems; and
a frame member which provides, structural support to the table and which extends substantially horizontally when the table is in use, the frame member constituting the second component of all of said systems.
